(19) United States
(12) Patent Application Publication
(10) Pub. No.: US 2026/0067793 A1
(43) Pub. Date: Mar. 5, 2026

(54) ACCESS POINT BSSID MAC ROTATION

(71) Applicant: Cisco Technology, Inc., San Jose, CA (US)

(72) Inventors: Robert E. BARTON, Richmond (CA); Jerome HENRY, Pittsboro, NC (US); Malcolm M. SMITH, Richardson, TX (US)

(21) Appl. No.: 19/281,561

(22) Filed: Jul. 26, 2025

Related U.S. Application Data
(60) Provisional application No. 63/691,014, filed on Sep. 5, 2024.

(51) Int. Cl. H04W 48/16; H04W 48/08; H04W 84/12

(52) U.S. Cl. CPC H04W 48/16; H04W 48/08; H04W 84/12

(57) ABSTRACT

In wireless deployments, the basic service set (BSS) identifier (ID) is the MAC address of an access point (AP). That is, each time the AP sends or receives (unicast of multicast/broadcast frames), the BSSID appears in the frame as either the transmit or receive address. The embodiments herein discuss techniques for changing (or rotating) the BSS ID of an AP.

### CROSS-REFERNCE TO REALTED APPLICATIONS

This application claims benefit of co-pending United States provisional patent application Serial No. 63/691,014 filed September 5, 2024. The aforementioned related patent application is herein incorporated by reference in its entirety.

### TECHNICAL FIELD

Embodiments presented in this disclosure generally relate to changing (or rotating) a basic service set (BSS) identifier (ID) of an access point (AP).

### BACKGROUND

Randomized and Changing MAC Addresses (RCM) is a privacy feature in which a wireless device (e.g., a station (STA)) generates random MAC addresses when connecting to Wi-Fi networks instead of using the hardware-assigned, unique MAC address (known as the Burn-In Address or BIA). MAC addresses, being unique identifiers, can be used by network operators and others to track a STA’s location, usage patterns, and potentially even the user's identity. RCM makes such tracking more difficult by using a different, randomized MAC address for each Wi-Fi network a device connects to, or by rotating it at regular intervals.

By rotating the MAC address, the association between a specific STA and a single identifier is broken, making it harder to link network activities to a particular user or device. Moreover, RCM can help prevent unauthorized access and potential spoofing attacks that rely on knowing a STA’s consistent MAC address. In sum, RCM enhances user privacy by reducing the ability of third parties to track devices across different Wi-Fi networks or over time in the same Wi-Fi network using their MAC addresses. While according to IEEE, an access point (AP) is a type of STA, there have been very few technique developed for rotating MAC addresses of an AP, as RCM is focused on STAs that are user devices instead of infrastructure devices like an AP.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates changing the BSS ID of an AP, according to one embodiment.

FIG. 2 is a flowchart for periodically changing the BSS ID of an AP, according to one embodiment.

FIG. 3 is a flowchart for overlapping BSS IDs when changing the BSS ID of an AP, according to one embodiment.

FIG. 4 is a flowchart for setting a buffer period in response to an ongoing AP/STA exchange, according to one embodiment.

FIG. 5 is a flowchart for extending a buffer period in response to an ongoing AP/STA exchange, according to one embodiment.

FIG. 6 is a flowchart for coordinating changes to BSS IDs among a plurality of APs, according to one embodiment.

FIG. 7 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure is an AP that includes one or more memories and one or more processors communicatively coupled to the one or more memories, wherein the one or more processors are configured to, individually or collectively, perform operations. The operations include transmitting a first frame containing a first basic service set (BSS) identifier (ID) of the AP, upon determining a time period has expired, selecting a second BSS ID for the AP, and transmitting a second frame containing the second BSS ID of the AP.

One embodiment presented in this disclosure is a method that includes transmitting a first frame containing a first BSS ID of an AP, upon determining a time period has expired, selecting a second BSS ID for the AP, and transmitting a second frame containing the second BSS ID of the AP.

One embodiment presented in this disclosure is a non-transitory computer readable medium storing instructions that, when executed by one or more processors, cause the one or more processors to, individually or collectively, perform operations. The operations include transmitting a first frame containing a first BSS ID of the AP, upon determining a time period has expired, selecting a second BSS ID for the AP, and transmitting a second frame containing the second BSS ID of the AP.

### EXAMPLE EMBODIMENTS

In Wi-Fi deployments, the BSS ID is the MAC address of the AP. That is, each time the AP sends or receives (unicast of multicast/broadcast frames), the BSSID appears in the frame as either the transmit or receive address. The embodiments herein discuss techniques for changing (or rotating) the BSS ID of an AP. There are several reasons why BSS ID rotation (e.g., MAC rotation) on APs is useful. For example, when the BSSID (MAC) of an AP is publicly broadcasted, it presents an obvious target for malicious attackers. Additionally, owners of public buildings may not want Wi-Fi device vendors to offer uncontrolled MAC address maps of venues (for example, the owners may want to encourage the use of their own VIP app). In another example, some venues are “pop-up” in nature where a crowd sourcer may record the BSS ID of an AP in at one event, and the same BSS ID a few months later for another event with the same Wi-Fi provider, which provides the crowd sourcer with the ability to track users.

In addition, rotating the BSSID of a home AP, or a virtual AP on a phone (e.g., a personal hotspot) can be helpful because these real and virtual APs are associated with personal identifiable information (PII) which should be obfuscated. Additionally, the AP identity in a multi-AP coordination (MAPC) group or during seamless roaming orchestration also should be protected/obscured since the AP may exchange network information with potentially nefarious/rogue STAs, P2P STAs, mobile or other APs that could be leveraged for a later attack (e.g. a replay attack).

As mentioned above, the AP uses a BSS ID for unprotected advertisements (e.g., beacons/probe responses), allowing clients to discover the AP. In the embodiments herein, the public BSSID lifetime is limited by the AP. In one embodiment, the BSS ID is changed or rotated (e.g., using a pseudo-random rotation process) according to a timer, which could be a constant time interval or a random or pseudo-random time interval. The AP can change its BSS ID according to the timer for these public frames. However, an abrupt change to the BSS ID could affect clients that have established a non-associated state (e.g., as defined in IEEE 802.11-2020 12.2.10) with the AP (e.g., STAs that are progressing through the association phases or STAs performing Access Network Query Protocol (ANQP), Fine Timing Measurement (FTM), or other unassociated exchanges). These stateful exchanges between the AP and the non-associated STAs may fail if the BSS ID is changed abruptly.

To enable stateful exchanges to continue during a BSS ID rotation, in one embodiment the AP can enable or support multiple BSS IDs (e.g., the BSS IDs can overlap). When deciding to rotate the BSS ID, the AP can advertise both the new and old BSS IDs. After a period of time, the AP stops advertising the old BSS ID and only advertises the new BSS ID, but nonetheless continues to accept traffic on the old BSS ID (so the stateful exchanges started using the old BSS ID can continue). Eventually, the AP stops accepting traffic on the old BSS ID (the old BSS ID is completely removed). However, the AP can set (or extend) the time before it disables the old BSS ID to allow sufficient time for any stateful exchange to complete.

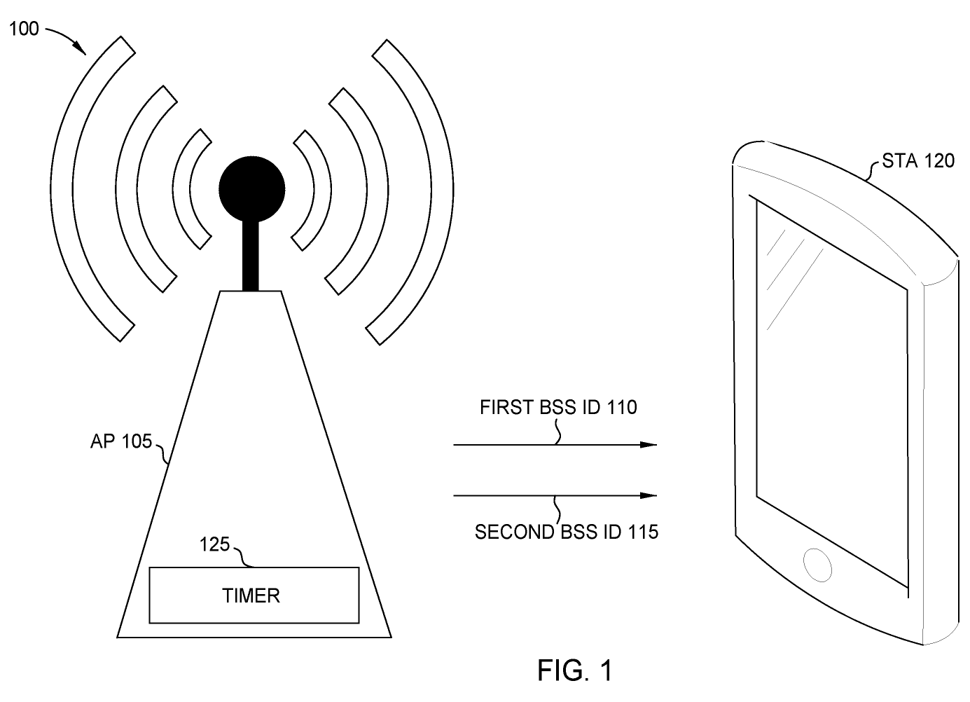

FIG. 1 illustrates changing the BSS ID of an AP, according to one embodiment. FIG. 1 illustrates an AP 105 and a STA 120 (e.g., a mobile phone, tablet, laptop, desktop computer, etc.). In one embodiment it is assumed that the STA 120 has not already associated with the AP 105 (i.e., the STA 120 is a non-associated STA). For example, the STA 120 may be in the process of associating with the AP 105 by exchanging unencrypted messages. In another example, the STA 120 may be performing ANQP or FTM which involves transmitting unencrypted messages to the AP 105. As such, during these exchanges the BSS ID of the AP 105 is also unencrypted, and as such, can be read by a nefarious actor. This can lead to the security issues and privacy concerns described above.

The embodiments herein describe changing or rotating the BSS ID of the AP 105 for unencrypted messages. FIG. 1 illustrates that the AP 105 transmits unencrypted messages (beacons/probe responses) using a first BSS ID 110 to the STA 120. That is, these messages include the BSS ID 110 (e.g., the APs 105 MAC address). Using a timer 125, the AP 105 can determine when to switch from the first BSS ID 110 to a second BSS ID 115. For example, the timer 125 may switch the BSS ID of the AP 105 at set intervals (e.g., every couple of minutes). In other embodiments, the timer 125 may be a random or pseudo-random timer where the intervals at which the AP 105 switches between the first and second BSS IDs 110, 115 changes.

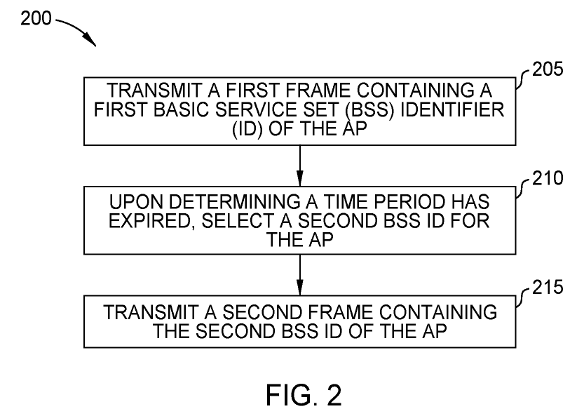

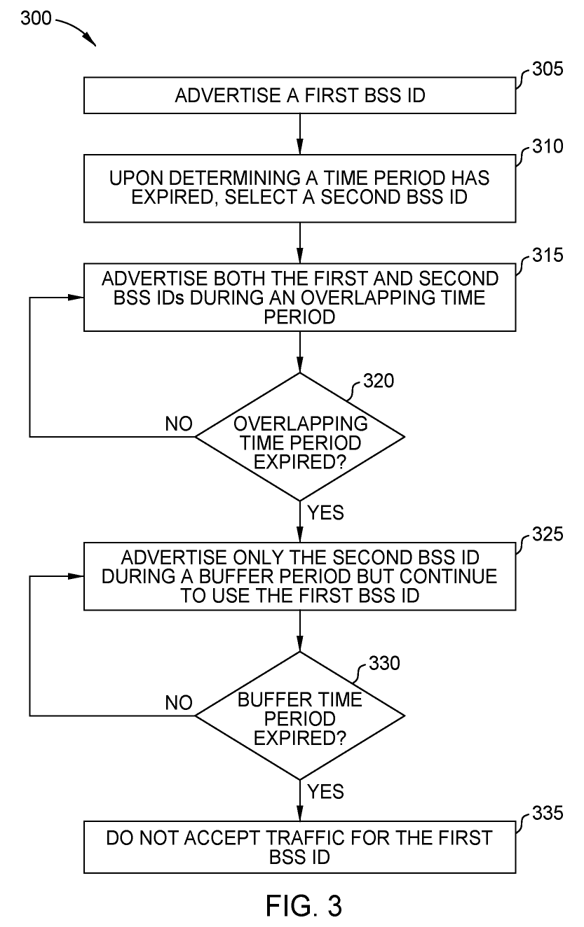

After the timer 125 expires, the AP 105 begins transmitting unsecure messages to the STA 120 that contain the second BSS ID 115, which is discussed in more detail in FIG. 2. For messages (or frames) that serve as unprotected advertisements, changing between the first BSS ID 110 and the second BSS ID 115 will not likely have a negative impact on the STA 120. That is, the STA 120 can still discover the AP 105 from these advertisements. However, as mentioned above, if the STA 120 has already begun a stateful exchange with the AP 105 (e.g., as part of the association process, or when performing ANQP or FTM), changing the BSS ID in the middle of this exchange can cause the exchange to fail. Thus, in some embodiments, instead of simply switching between the BSS IDs, the AP 105 can perform a graceful transition as discussed in FIG. 3.

FIG. 2 is a flowchart or a method 200 for periodically changing the BSS ID of an AP, according to one embodiment. At block 205, an AP (e.g., the AP 105 in FIG. 1) transmits a first frame containing a first BSS ID. In one embodiment, the first frame is an unsecured frame. For example, the first frame can be an unsecured advertisement, a message sent as part of an association process with a STA, a message that is part of ANQP or FTM, and the like.

At block 210, upon determining a time period has expired, the AP selects a second BSS ID. For example, the time period can be controlled using a timer (e.g., the timer 125 in FIG. 1) which can be set to rotate the BSS ID at a set interval, or at random intervals.

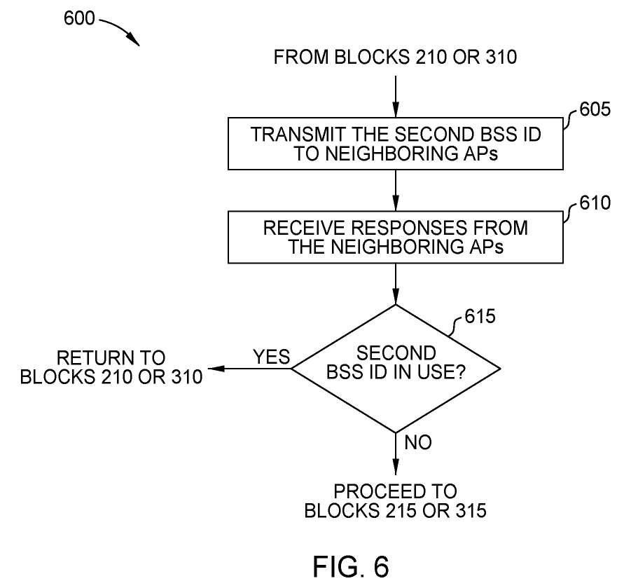

There are many different techniques for selecting the second (or next) BSS ID (e.g., performing a pseudo-random rotation process). The embodiments herein are not limited to any particular method, but some suitable techniques are discussed. In one embodiment, the AP can use a seed value as an input to a Pseudo-Random Number Generator (PRNG) which is an algorithm that produces a sequence of numbers that appear random but are actually generated by a deterministic process using the seed. This seed itself could be a randomly generated value. In another embodiment, the seed could be a fixed value. For example, the serial number of the AP could be used as the seed. This could be advantageous since if each AP in a deployment (e.g., each AP in the same extended service set (ESS)) use their respective serial numbers (which are guaranteed to be unique), they will not select the same BSS ID, and thus, there is no coordination needed between the APs to ensure they do not change to the same BSS ID. However, as discussed in FIG. 6, there can be coordination between APs to ensure the same BSS ID is not used by multiple APs in the ESS if the technique used to select the second BSS ID does not ensure it is unique.

At block 215, the AP transmits a second frame containing the second BSS ID selected at block 210. While this can be an abrupt change where the AP switches from the first BSS ID directly to the second BSS ID (e.g., the AP begins advertising the second BSS ID and completely removes the first BSS ID), in other embodiments, the AP may use an overlapping time period where both the first and second BSS IDs are advertised and/or supported. This is discussed next in FIG. 3. There may be situations where an abrupt change from the first to the second BSS ID is sufficient, but the graceful or smooth transition discussed in FIG. 3 may be less disruptive since it enables stateful exchanges between the AP and STAs to continue.

FIG. 3 is a flowchart for overlapping BSS IDs when changing the BSS ID of an AP, according to one embodiment. At block 305, the AP advertises a first BSS ID. As above, the BSS ID may be used in unencrypted frames for advertisements or to perform association, ANQP, FTM, and the like.

At block 310, upon determining a time period has expired, selecting a second BSS ID. This can be performed using any of the techniques discussed above (e.g., at block 210 of FIG. 2).

At block 315, the AP advertises both the first and second BSS IDs during an overlapping time period. During this time period, both the first and second BSS IDs are active. Stated differently, the AP has overlapping BSS IDs. For example, the AP can send beacons from both addresses. As such, there are two active BSSIDs which may be used by STAs during this time period.

The duration of the overlapping time period can be adjustable. For example, the duration may be long enough that STAs that received the first BSS ID in a beacon (e.g., before the second BSS ID was transmitted) have time to at least start an exchange using the first BSS ID (e.g., start association using the first BSS ID). In one embodiment, the duration of the overlapping time period is less than the time period used to determine when to switch between the old and new BSS IDs.

At block 320, the AP determines if the overlapping time period has expired. If not, the AP returns to block 315 where it continues to advertise and support overlapping BSS IDs. However, if the overlapping time period has expired, the method 300 proceeds to block 325 where the AP advertises only the second BSS ID during a buffer time period, but continues to use (or support) the first BSS ID. That is, the AP discontinues advertisements from the first BSS ID, but still accepts, and responds to, messages sent to the first BSS ID (e.g., authentication or probe requests, or requests from STAs that recorded the presence of that BSSID/AP on that channel). As such, during the buffer time period the AP continues to support overlapping BSS IDs but does not advertise the first BSS ID.

During the buffer time period, any new STA that receives a beacon from the AP will see only the second BSS ID, and thus, will not know about the first BSS ID. As such, new STAs will attempt an association to the second BSSID because from their perspective the first BSS ID is not visible. Nonetheless, the AP still accepts responses on the first BSSID, allowing "grandfathered" stateful exchanges to complete.

In sum, during this time period, the AP supports overlapping BSS IDs, and as such, accepts requests to the second BSS ID as well as requests from STAs that have already started a stateful exchange with the AP using the first BSS ID. These STAs can continue to transmit frames to the AP to continue the exchange (e.g., continue an association/ANQP/FTM process).

While method 300 illustrates at block 315 advertising both the first and second BSS IDs, in another embodiment, the method 300 may omit this step and skip directly to block 325 where only the second BSS ID is advertised. In that example, the first BSS ID could still be used by the AP and STA to continue any exchanges that have already started (i.e., the AP supports overlapping BSS IDs), but the AP would immediately stop advertising the first BSS ID in beacons and only advertise the second BSS ID (rather than advertising both).

At block 330, the AP determines whether the buffer time period has expired. If not, the method 300 returns to block 325. If so, the method 300 proceeds to block 335. However, if the buffer time period has expired, the method 300 proceeds to block 335 where the AP does not accept traffic for the first BSS ID.

At block 335, the AP no longer accepts responses from the first BSS ID (i.e., the first BSS ID is removed completely). From this point of time and onward, the AP only uses the second BSS ID, and the first BSS ID is no longer advertised or used. Block 335 is similar to block 305 but where the AP has a new BSSID. That is, any advertisement from the STA only includes the second BSS ID, and the AP does not recognize any (or ignores all) messages for the first BSS ID.

The method 400 can then return to block 310 where the process now repeats at the next rotation cycle. That is, blocks 310-335 can repeat, but this time the AP can transition from the second BSS ID to a new, third BSS ID.

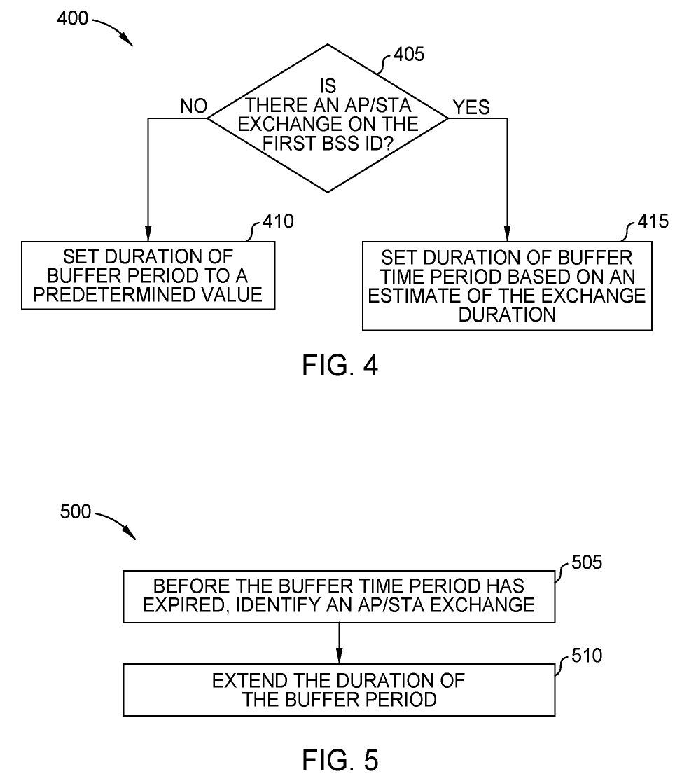

FIG. 4 is a flowchart of a method 400 for setting a buffer period in response to an ongoing AP/STA exchange, according to one embodiment. That is, the method 400 can be used to set the buffer time period described at block 325 where the second BSS ID is advertised by the AP, but the AP continues to support the first BSS ID (e.g., so that stateful exchanges can continue). The AP can use the method 400 to determine the length of the buffer time period to give sufficient time for the stateful exchanges to complete before the AP no longer supports the first BSS ID.

At block 405, the AP determines whether there is an AP/STA exchange currently happening on the first BSS ID. That is, the AP can determine if any STA has started a stateful exchange (e.g., an association request, authentication, ANQP process, or FTM process) using the first (or old) BSS ID.

If there are currently no stateful exchanges taking place on the AP, the method 400 proceeds to block 410 where the AP sets the duration of the buffer period to a predetermined value. For example, the AP may still want to support the first BSS ID during the buffer period for a short period of time just to ensure all stateful exchanges have completed.

Alternatively, if there are currently no stateful exchanges taking place on the AP, the AP may decide to completely skip the buffer time period. In that case, the AP may immediately proceed to block 335 where the AP no longer supports the first BSS ID. Put differently, if there are no stateful exchanges on the first BSS ID, the AP can only advertise the second BSS ID and no longer support any traffic for the first BSS ID.

However, if the AP determines that there is at least one ongoing exchange on the AP, the method 400 proceeds to block 415 where the AP sets a duration of the buffer time period based on an estimate of the exchange duration. For example, different stateful exchanges may take longer than other types of exchanges. Depending on the type of the stateful exchange (e.g., an association request, authentication, ANQP process, or FTM process), the AP can select a duration for the buffer time period that matches the typical duration of that stateful exchange.

Further, the AP may consider the particular stage of the stateful exchange when setting the duration of the buffer time period. That is, the STA may be at different stages in the stateful exchange. For example, the onboarding process to associate the STA to the AP can include different stages: discovery, authentication, association, and post-association authentication. The AP may set a smaller duration for the buffer time period if a STA is in the authentication stage versus when a STA is already in the association stage since that STA may need less time to complete onboarding (i.e., complete the stateful exchange)

In addition, there may be multiple stateful exchanges occurring on the AP in the first BSS ID. The AP can estimate a duration for each of these stateful exchanges and then select the maximum duration to use as the buffer time period. This ensures that each of the stateful exchanges should have sufficient time to complete before the buffer time period expires, and the first BSS ID is removed.

Once the buffer time period is set either at block 410 or 415, the method 400 can then proceed to block 325 of the method 300.

FIG. 5 is a flowchart for extending a buffer period in response to an ongoing AP/STA exchange, according to one embodiment. That is, the method 500 can be used to extend the buffer time period described at block 325 where the second BSS ID is advertised by the AP, but the AP continues to support the first BSS ID (e.g., so that stateful exchanges can continue).

Unlike in method 400 where the AP sets the duration of the buffer time period to an initial value based on the current exchanges, in method 500 the AP can extend the buffer time period when this phase has already started. For example, the AP may always set the buffer time period to a predetermined value (without checking if there are any current stateful exchanges) and then use method 500 to later determine whether the buffer time period should be extended to give a stateful exchange time to complete.

At block 505, before the buffer time has expired, the AP identifies an AP/STA exchange. For example, the AP can use the initial duration of the buffer time period to determine whether there are any STAs that continue to use the first BSS ID to complete a stateful exchange. If during this time period the AP does not identify any AP/STA exchanges using the first BSS ID, then the AP can let the buffer time period expire. That is, the AP can then proceed to block 325 of the method 300 where the AP no longer supports the first BSS ID.

However, assuming that the AP does identify an ongoing exchange using the first (old) BSS ID during the buffer time period, at block 510 the AP extends the duration of the buffer time period. This could be done by the AP adding a predetermined extension time to the buffer time period (e.g., adding another second to the duration of the buffer time period). The AP could then check at near the end of the extended time period whether the stateful exchanges on the first BSS ID have completed. If not, the AP can extend the buffer time period again (e.g., add another second to the duration of the buffer time period). This can repeat until the exchanges in the first BSS ID are complete.

In another example, the AP could extend the duration of the buffer time period based on an estimate of the exchange duration, like as discussed at block 415 in method 400. In this case, the AP could extend the duration based on the type of the exchange. Or the AP could extend the duration based on the current stage of the exchange (e.g., if the exchange is at an earlier or later stage within the exchange). In this manner, the buffer time period is extended so it expires once (or soon after) the AP/STA exchange is complete. Moreover, if there are multiple AP/STA exchanges on the old BSS ID, the AP can extend the buffer time period to accommodate the exchange that is estimated to take the longest time.

FIG. 6 is a flowchart of a method 600 for coordinating changes to BSS IDs among a plurality of APs, according to one embodiment. One constraint on BSS/MAC rotation on an AP is that there are a finite number of MAC addresses assigned to a device (e.g., a device is often assigned a range of 16 MAC addresses). This constraint can be avoided by using virtual APs. If a single, physical AP offers more than one SSID or BSSID, then the AP uses different BSS IDs from different virtual APs.

In one embodiment, the AP can rotate every virtual AP supported by that AP in parallel (e.g., at the same time). For example, when the timer expires (e.g., when the timer 125 in FIG. 1 expires), the AP can randomly select a new BSS ID for each virtual AP and change them in parallel using any of the techniques discussed above in FIGS. 1-5.

In another embodiment, the AP consumes the SSID of a virtual AP during a transition phase to avoid an SSID unavailability. The AP can assume the SSID of a virtual AP, e.g., the SSID is not rotated it during the transition.

In another embodiment, it may be advantageous to avoid rotating the BSS ID using the MAC address that was assigned to the AP at the time it was manufactured. This MAC address can include an organizationally unique identifier (OUI) which permits anyone who receives a message with this MAC address to identify the vendor of the AP. However, if BSS ID rotation is not based on this MAC address, then it is possible that neighboring APs in a multi-AP deployment may rotate and select the same BSS ID. This can result in an overlapping basic service set (OBSS) that can cause interference between neighboring APs which can lead to reduced network performance due to increased contention for the wireless medium. The method 600 illustrates techniques for neighboring APs to ensure they do not select the same BSS values when rotating their BSS IDs.

The method 600 may begin after blocks 210 or 310 in FIGS. 2 and 3 have been performed (e.g., where the AP has determined to rotate to a second BSS ID).

At block 605, the AP transmits the second BSS ID to neighboring APs. That is, before the AP changes from the first BSS ID to the second BSS ID (e.g., before the AP advertises the second BSS ID), the AP can transmit the second BSS ID to its neighbors. This message can indicate that the neighboring APs should determine whether they are, or are planning on using the second BSS ID. Further, even if the neighboring APs are not planning on using the second BSS IDs, the neighboring APs can also report whether they are received any beacons from any other AP that advertised the second BSS ID.

In one embodiment, the AP can use Inter-Access Point Protocol (IAPP) to communicate with its neighboring APs. IAPP is a protocol that enables APs to communicate with each other, especially when a wireless client roams from one AP to another. This communication can be leveraged in this situation to exchange BSS IDs between the APs.

At block 610, the AP receives a response for the neighboring APs. The response can indicate whether the neighboring APs are using the second BSS ID, plan on using the second BSS ID, or have received a beacon with the second BSS ID.

At block 615, if the AP determines from a neighboring AP that the second BSS ID is (or will be) in use, the method 600 can return to blocks 210 and 310 where the AP selects another BSS ID. The method 600 can then repeat where the AP checks with the neighboring APs to determine whether the new BSS ID is in use.

However, if at block 615 the AP determines from the neighboring AP that the second BSS ID is not in use, the method 600 proceeds to block 215 or 315 where the AP can continue the process to rotate from the first (old) BSS ID to the second (new) BSS ID.

In another embodiment, the AP performs a discovery exchange at a MAC level over the air with the neighboring APs. The AP can signal to other APs what MAC address (e.g., what BSS ID) it is currently using (e.g., at block 605). Any AP already using the requested MAC, or detecting in its environment another AP (inside or outside the ESS) that is using the MAC, replies that the MAC is already in use (e.g., block 610). This causes the requesting AP to request another address (e.g., proceed to block 210 or 310). If there are no collisions, the AP can continue with the BSS ID rotation (e.g., proceed to block 215 or 315).

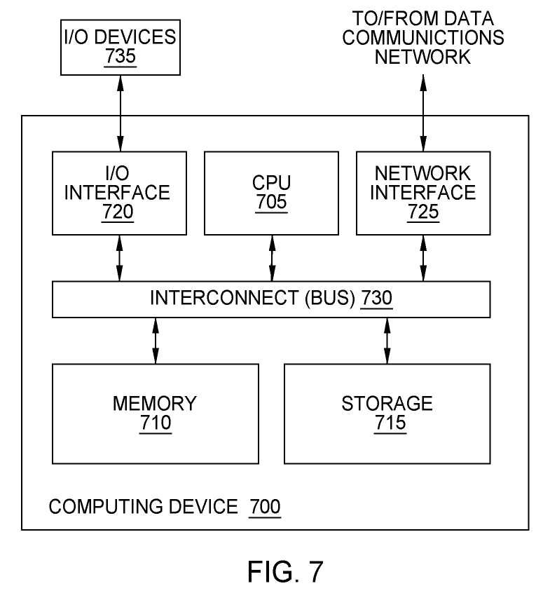

FIG. 7 depicts an example computing device configured to perform various aspects of the present disclosure, according to one embodiment. Although depicted as a physical device, in embodiments, the computing device 700 may be implemented using virtual device(s), and/or across a number of devices (e.g., in a cloud environment). In one embodiment, the computing device 700 corresponds to a network device (e.g., a computing system), such as the APs or the STAs (e.g., user devices) mentioned above.

As illustrated, the computing device 700 includes a CPU 705 (one or more processors), memory 710 (or memories), storage 715, a network interface 725, and one or more input/output (I/O) interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

The memory 710 can include software programs or application for changing (or rotating) the BSS ID of an AP as discussed above in FIGS. 1-6. Although shown as residing in memory 710, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP), comprising:
one or more memories; and
one or more processors communicatively coupled to the one or more memories, wherein the one or more processors are configured to, individually or collectively, perform operations comprising:
transmitting a first frame containing a first basic service set (BSS) identifier (ID) of the AP;
upon determining a time period has expired, selecting a second BSS ID for the AP; and
transmitting a second frame containing the second BSS ID of the AP, wherein the both the first and second BSS IDs are active at the AP during an overlapping time period.

2. The AP of claim 1, wherein the second BSS ID is selected using a pseudo-random rotation process.

3. The AP of claim 1, wherein the both the first and second BSS IDs are active for a period of time that is less than the time period.

4. The AP of claim 1, wherein the second frame is transmitted during the overlapping time period when both the first and second BSS IDs are active and contains both the second BSS ID and the first BSS ID.

5. The AP of claim 1, wherein the second frame is transmitted during the overlapping time period when both the first and second BSS IDs are active and contains the second BSS ID but not the first BSS ID.

6. The AP of claim 1, wherein the operations comprises:
after the overlapping time period has expired but before a buffer period has expired, transmitting a third frame containing the second BSS ID but not the first BSS ID, wherein the AP is configured to still respond to messages received using the first BSS ID during the buffer period but the AP does not advertise the first BSS ID during the buffer period.

7. The AP of claim 6, wherein, after the buffer period has expired, the AP is configured to no longer use the first BSS ID.

8. The AP of claim 7, wherein the operations comprises:
identifying an ongoing exchange between the AP and a STA using the first BSS ID; and
at least one of:
setting a duration of the buffer period based on an estimated length of time until the ongoing exchange will complete, or
extending the duration of the buffer period to provide additional time for the ongoing exchange to complete before the buffer period expires.

9. The AP of claim 1, wherein the operations comprises:
upon determining the time period has expired, rotating BSS IDs for a plurality of virtual APs established by the AP in parallel.

10. The AP of claim 1, wherein the operations comprises, before using the second BSS ID:
transmitting the second BSS ID to a neighboring AP; and
receiving a response from the neighboring AP indicating the neighboring AP is not using the second BSS ID, or has not detected the second BSS ID.

11. A method comprising:
transmitting a first frame containing a first basic service set (BSS) identifier (ID) of an access point (AP);
upon determining a time period has expired, selecting a second BSS ID for the AP; and
transmitting a second frame containing the second BSS ID of the AP wherein the both the first and second BSS IDs are active at the AP during an overlapping time period.

12. The method of claim 11, wherein the second BSS ID is selected using a pseudo-random rotation process.

13. The method of claim 11, wherein both the first and second BSS IDs are active for a time period that is less than the time period.

14. The method of claim 11, wherein the second frame is transmitted during the overlapping time period when both the first and second BSS IDs are active and contains both the second BSS ID and the first BSS ID.

15. The method of claim 11, wherein the second frame is transmitted during the overlapping time period when both the first and second BSS IDs are active and contains the second BSS ID but not the first BSS ID.

16. The method of claim 11, further comprising:
after the overlapping time period has expired but before a buffer period has expired, transmitting a third frame containing the second BSS ID but not the first BSS ID, wherein the AP is configured to still respond to messages received using the first BSS ID during the buffer period but the AP does not advertise the first BSS ID during the buffer period.

17. The method of claim 16, wherein, after the buffer period has expired, the AP is configured to no longer use the first BSS ID.

18. The method of claim 17, further comprising:
identifying an ongoing exchange between the AP and a STA using the first BSS ID; and
at least one of:
setting a duration of the buffer period based on an estimated length of time until the ongoing exchange will complete, or
extending the duration of the buffer period to provide additional time for the ongoing exchange to complete before the buffer period expires.

19. The method of claim 11, further comprising:
upon determining the time period has expired, rotating BSS IDs for a plurality of virtual APs established by the AP in parallel.

20. A non-transitory computer readable medium storing instructions that, when executed by one or more processors, cause the one or more processors to, individually or collectively, perform operations comprising:
transmitting a first frame containing a first basic service set (BSS) identifier (ID) of an access point (AP);
upon determining a time period has expired, selecting a second BSS ID for the AP; and
transmitting a second frame containing the second BSS ID of the AP.
